(19) United States
(12) Patent Application Publication
(10) Pub. No.: US 2008/0128188 A1
(43) Pub. Date: Jun. 5, 2008

(54) Method and device for generating mechanical energy

(76) Inventor: Lutz Giechau, Coppenbrugge (DE)

Correspondence Address: MANFRED BECK, P.A., 830 TYLER STREET, HOLLYWOOD, FL, 33019-1327, US

(21) Appl. No.: 11/949,031

(22) Filed: Dec. 1, 2007

Related U.S. Application Data
(63) Continuation of application No. PCT/DE2006/000884, filed on May 22, 2006.

(30) Foreign Application Priority Data
Jun. 2, 2005 (DE) 10 2005 025 255.9
May 11, 2006 (DE) 10 2006 021 928.7

(51) Int. Cl. B60K 6/00; F01K 13/00; F01K 7/16

(52) U.S. Cl. 180/65.3; 60/645; 60/670

(57) ABSTRACT

A method for producing mechanical energy with a rotating thermal engine includes using a first liquid working medium and at least one further liquid working medium. The at least one further working medium has a lower boiling temperature than the first working medium. When the at least one further liquid working medium is combined with the first working medium that is enriched with thermal energy, it changes to a gaseous state or expands and produces an overpressure and performs work in such a manner that a torque is applied to a rotating part of the rotating thermal engine. A device for producing mechanical energy is also provided.

### CROSS-REFERENCE TO RELATED APPLICATIONS

This application is a continuation, under 35 U.S.C. § 120, of copending International Application No. PCT/DE2006/000884, filed May 22, 2006, which designated the United States; this application also claims the priority rights, under 35 U.S.C. § 119, of German Patent Application No. DE 10 2005 025 255.9, filed Jun. 2, 2005 and of German Patent Application No. DE 10 2006 021 928.7, filed May 11, 2006; the prior applications are herewith incorporated by reference in their entirety.

### FIELD OF THE INVENTION

The invention relates to a method and a device for generating mechanical energy through the use of a rotating thermal engine having a housing part with at least one inlet duct and an outlet duct and at least one part which rotates in the housing part, wherein thermal energy is converted into mechanical work and wherein the working media that are used pass through a circulation process.

### BACKGROUND OF THE INVENTION

Thermal engines or thermal power systems which themselves carry out thermodynamic circulation processes in order to perform mechanical work and subsequently generate electrical current have been known for a long time. In this regard reference is made to Beitz, W. and Grote, K.-H. (Eds.) “Dubbel: Taschenbuch für den Maschinenbau” [Dubbel: Handbook for Mechanical Engineering], 20th edition, published by Springer Verlag, pages D18-D21. According to this handbook, turbine systems and steam power systems are predominantly used.

In closed gas turbine systems, a gas is compressed in a compressor, heated to a high temperature in a heat exchanger or gas heater and then relaxed in a turbine accompanied by the performance of work, and cooled again to the initial temperature in the heat exchanger and the adjoining cooler, downstream of which the gas is sucked in by the compressor again. Air, but also helium and nitrogen, can be used as the working media. The relatively high energy costs for ensuring the process prove to be one of a number of disadvantages.

In contrast, steam power systems are operated with a working medium, usually water, which vaporizes during the process and is condensed again. In its simplest form, the working process is carried out in such a way that in a tank the working medium (water) is heated to the boiling point at high isobar pressure, vaporized and subsequently also superheated in what is referred to as a superheater. The steam is then relaxed adiabatically in a turbine accompanied by the performance of work, and is liquefied in a condenser accompanied by the emission of heat. A water pump brings the pressure of the liquid up to a tank pressure and the liquid is fed back into the tank. Here too, considerable quantities of energy are necessary to maintain the circulation process.

Furthermore, German Patent Application Publication No. DE 196 51 645 A1 and corresponding U.S. Pat. No. 6,141,949 disclose a method for using solar energy in a gas and steam power plant. Essentially, it is proposed here that thermal energy be fed to the heat transfer medium or working medium in the gas turbine circuit through the use of solar radiation.

Finally, U.S. Pat. No. 3,972,195 discloses a method for generating mechanical energy through the use of a rotating thermal engine with a housing part with an inlet duct and an outlet duct and a rotor part which is disposed in the housing part, wherein thermal energy is converted into mechanical energy by virtue of the fact that two initially liquid working media pass through a working process in such a way that a first working medium is enriched with thermal energy and the second working medium has a lower boiling temperature than the first so that the second working medium which is capable of vaporizing goes into a gaseous aggregate state on contact with the first working medium which is enriched with thermal energy. The two working media are combined within a nozzle so that as a result a “two-phase jet”, i.e. a flow at a high speed, composed of a liquid working medium and a gaseous working medium is generated and strikes rotor blades of the rotor and drives the same owing to the increased flow energy.

### SUMMARY OF THE INVENTION

It is accordingly an object of the invention to provide a method for generating mechanical energy through the use of a rotating thermal engine which, compared to the prior art, requires relatively small quantities of thermal energy in order to ensure a thermodynamic circulation process for performing mechanical work that can be utilized. A further object of the invention is to provide a suitable device for carrying out the method.

With the foregoing and other objects in view there is provided, in accordance with the invention, a method for generating mechanical energy, which includes the following steps:

providing a rotating thermal engine having a housing part, at least one inlet duct, an outlet duct, and at least one rotating part rotating in the housing part, wherein thermal energy is converted into mechanical work and working media pass through a circulation process;

carrying out the following steps successively in a closed system which is initially provided with a given partial vacuum;

a) supplying thermal energy to a first working medium in a liquid state;

b) feeding the first working medium, which is enriched with thermal energy, in a liquid state to at least one working chamber which is formed by the housing part and the at least one rotating part which is disposed in the housing part;

c) feeding at least one further working medium in a liquid state to the first working medium in the liquid state within the at least one working chamber, the at least one further working medium having a boiling temperature that is lower than a boiling temperature of the first working medium, wherein the at least one further working medium changes into a gaseous state or expands as a result of being combined with the first working medium enriched with thermal energy, and the at least one further working medium generates an overpressure and performs work in such a way that a torque is applied to the rotating part;

d) extracting, after a given rotation of the at least one rotating part, a working media mixture which is composed of the first working medium and the at least one further working medium, wherein the working media mixture is extracted from the at least one working chamber through the outlet duct in the housing part as a result of a partial vacuum present at the outlet duct, and subsequently cooling the working media mixture, as a result of which a continuous pressure gradient in a system is maintained in order to extract a following working media mixture and to ensure a continuous circulation process; and

e) spatially separating the working media from one another and feeding the working media back into the circulation process and, respectively, into separate circuits.

In other words, according to the invention, there is provided a method for generating mechanical energy through the use of a rotating thermal engine, having a housing part with at least one inlet duct and one outlet duct and at least one part which rotates in the housing part, wherein thermal energy is converted into mechanical work and working media which are used pass through a circulation process, in such a way that the following method steps are carried out successively in a closed system which is initially provided with a certain degree of partial vacuum:

a) thermal energy is fed to a first liquid working medium,

b) the first working medium which is enriched with thermal energy is fed in the liquid state to at least one working chamber which is formed by the housing part and the rotating part which is disposed in the housing part,

c) at least one further liquid working medium with a lower boiling temperature than the first liquid working medium is fed to the first liquid working medium directly upstream of and/or within the at least one working chamber, wherein the at least one further working medium changes or expands into a gaseous state owing to the combination with the first working medium which is enriched with thermal energy, and the further working medium generates an overpressure and performs work in such a way that a torque is applied to the rotating part,

d) after a defined rotation of the rotating part, the working media mixture which is composed of the first and the at least one further working media is extracted, as a result of a partial vacuum present at the outlet duct, from the at least one working chamber through the outlet duct in the housing part and subsequently cooled, as a result of which a continuous pressure gradient in the system is maintained in order to extract a subsequent mixture of working media and to ensure a continuous circulation process, and

e) the working media are spatially separated from one another and fed back into the circulation process or, respectively, into separate circuits.

Another mode of the method of the invention includes supplying the thermal energy for the first working medium by using at least one thermal energy-supplying device selected from the group of a solar collector, a photovoltaic cell generating electrical energy in conjunction with an electrically operated heating element, a heat storage device, an electric heating element, a heat pump, a combustion system, a heat exchanger and/or an internal combustion engine.

Another mode of the method of the invention includes feeding at least one of the first and the at least one further working medium to the at least one working chamber in a controlled manner by using a respective injection valve.

Another mode of the method of the invention includes determining a volume of the working media which are fed to the at least one working chamber in a computer-controlled manner in dependence on at least one sensed value selected from the group of a sensed current initial temperature, a sensed current initial pressure in the at least one working chamber, a current initial temperature of the first working medium and/or a current initial temperature of the at least one further working medium.

The inventive use of at least two working media which have different boiling temperatures permits in a particularly advantageous way a selective generation of gaseous working medium at given points in the immediate vicinity of the thermal engine, while, compared to conventional thermal engines, the necessary thermal energy for ensuring the continuous circulation process is substantially minimized.

In a further refinement of the method according to the invention there is provision for the thermal energy for the first working medium to be made available by one or more thermal energy supplying devices in the form of solar collectors, photovoltaic cells which generate electrical energy in conjunction with electrically operated heating elements, heat storage devices, electric heating elements per se, heat pumps, combustion systems, heat exchangers, internal combustion engines and/or the like.

As the invention also provides, the first and/or the at least one further working medium are fed to the working chamber under the control of a respective injection valve, as a result of which for example also temperature fluctuations and/or pressure fluctuations in the system, but also in the surroundings of the device, can be taken into account in order to ensure a continuous circulation process.

Accordingly, it is may be advisable that the volume of the working media which are fed to the at least one working chamber be determined under computer control as a function of the sensed current initial temperature and/or the sensed current initial pressure in the working chamber and/or the current initial temperature of the first and/or at least one further working medium.

With the objects of the invention in view there is also provided, a device for generating mechanical energy, including:

a rotating thermal engine having a housing part, at least one inlet duct, an outlet duct, and at least one rotating part rotating in the housing part;

the housing part and the at least one rotating part forming at least one working chamber;

working media passing through a circulation process, the working media including a first working medium and at least one further working medium, the working media being guided in respective circuits, the respective circuits and accordingly the working media being combined temporarily within the at least one working chamber formed by the housing part and the at least one rotating part disposed therein such that thermal energy is converted into mechanical work;

the at least one further working medium having a boiling temperature lower than a boiling temperature of the first working medium;

the rotating thermal engine, the first working medium and the at least one further working medium forming a closed system provided with a given partial vacuum during a start; and

the first working medium and the at least one further working medium having a liquid aggregate state at least at one of a start of the circulation process and immediately prior to entering the rotating thermal engine.

In other words, according to the invention, there is provided a device for generating mechanical energy through the use of a rotating thermal engine, having a housing part with at least one inlet duct and an outlet duct and at least one part which rotates in the housing part, wherein thermal energy is converted into mechanical work and working media which are used pass through a circulation process, the device being essentially defined by the fact that the device forms a closed system which is initially provided with a certain degree of partial vacuum, a first and at least one further working medium have a liquid aggregate state at least at the start of the circulation process or directly upstream of entry into the thermal engine and are guided in various circuits, the circuits and accordingly the working media are directly combined on a temporary basis immediately upstream of and/or within at least one working chamber, which is formed by the housing part and the rotating part disposed therein, of the thermal engine, and the at least one further working medium has a lower boiling temperature than the first working medium.

According to another feature of the invention, the rotating thermal engine is configured to be charged with the working media radially from outside and/or inside.

According to another feature of the invention, the first working medium is provided for absorbing thermal energy; the at least one further working medium is provided for performing work; and the at least one further working medium has a given boiling temperature such that the at least one further working medium is suitable for changing into a gaseous state on contact with the first working medium which is in a liquid aggregate state and enriched with thermal energy.

According to another feature of the invention, the rotating thermal engine has a rotationally fixed shaft embodied as a hollow shaft; the at least one rotating part of the rotating thermal engine is rotatably mounted on the rotationally fixed shaft; the hollow shaft has at least two media feed lines, the hollow shaft defines an axial direction and the at least two media feed lines extend in the axial direction; a first one of the at least two media feed lines is provided for the first working medium, and a further one of the at least two media feed lines is provided for the at least one further working medium; the hollow shaft has a lateral surface, the at least one inlet duct is configured as inlet ducts provided in the lateral surface of the hollow shaft; each of the at least two media feed lines is connected to at least a respective one of the inlet ducts in the lateral surface of the hollow shaft; and the inlet ducts are configured to be fluidically connectable, by rotating the at least one rotating part, to at least one opening formed in the at least one working chamber of the thermal engine.

According to another feature of the invention, the hollow shaft has a cavity formed therein; and the cavity is an axially divided cavity forming the at least two media feed lines.

According to another feature of the invention, the inlet ducts in the lateral surface of the hollow shaft and the at least one opening formed in the at least one working chamber of the rotating thermal engine are disposed in a manner corresponding with one another such that when the at least one rotating part rotates, the working media can be supplied successively and/or simultaneously to the at least one working chamber.

According to another feature of the invention, the at least two media feed lines have an overpressure applied thereto.

According to another feature of the invention, the housing part has at least one opening formed therein for additionally charging the at least one working chamber with the first working medium radially from outside.

According to another feature of the invention, at least one venting valve is disposed in the housing part, the at least one venting valve is configured such that an excess amount of the first working medium can escape during a charging of the at least one working chamber with at least one of the working media.

According to another feature of the invention, the housing part has at least one opening formed therein for additionally charging the at least one working chamber, which is already filled with the first and the at least one further medium, with the at least one further working medium.

According to another feature of the invention, the at least one rotating part is embodied as at least two substantially identically formed rotating parts disposed coaxially with respect to one another and rotationally fixed with respect to one another; and the at least two substantially identically formed rotating parts are rotatably mounted on the rotationally fixed shaft.

According to another feature of the invention, the at least two substantially identically formed rotating parts define a central axis and are disposed with an angular offset with respect to one another about the central axis such that an unbalance in a rotating system resulting from an expansion of a mixture of the working media is avoided.

According to another feature of the invention, the first working medium is guided in a given one of the circuits; and at least one thermal energy-supplying device selected from the group of a solar collector, a photovoltaic cell generating electrical energy in conjunction with an electrically operated heating element, a heat storage device, an electric heating element, a heat pump, a combustion system, a heat exchanger and/or an internal combustion engine is assigned to the given one of the circuits.

According to another feature of the invention, at least one respective feed pump is disposed in each respective one of the circuits for the working media.

According to another feature of the invention, the working media define a direction of flow; and a separating device is provided directly downstream of the rotating thermal engine viewed in the direction of flow of the working media, the separating device is configured to spatially separate the working media and to assign respective ones of the working media to respective ones of the circuits.

According to another feature of the invention, the separating device is a condensation component having a bottom and an upper region; and the separating device is configured such that the first working medium can be discharged at the bottom of the condensation component and the at least one further working medium, which is in a gaseous state, can be sucked off in the upper region of the condensation component and condensed by being cooled.

According to another feature of the invention, the condensation component has an integrated and extraneously driven piston-cylinder configuration configured to provide at least a defined support for a separation of the working media and a defined generation of a constant partial vacuum in the condensation component.

According to another feature of the invention, a given one of the circuits guides the first working medium and has a heat pump integrated therein, the heat pump has an evaporator connected to the condensation component for cooling the at least one further working medium which is sucked off in the upper region of the condensation component in the gaseous state.

According to another feature of the invention, at least one sensor is assigned to the rotating thermal engine, the at least one sensor determines at least one sensor value selected from the group of a current initial temperature value in the at least one working chamber, a current initial pressure value in the at least one working chamber, an initial temperature value of the first working medium and/or an initial temperature value of the at least one further working medium.

According to another feature of the invention, a computer unit is connected to the at least one sensor via an electrical connection or a contactless connection; the circuits include a first circuit for guiding the first working medium and a further circuit for guiding the at least one further working medium; the at least one inlet duct includes a first inlet duct for the first working medium and a further inlet duct for the at least one further working medium; a first injection valve is provided in the first circuit and is assigned to the first inlet duct; a further injection valve is provided in the further circuit and is assigned to the further inlet duct; and the computer unit generates control signals and is operatively connected to the first injection valve and/or the further injection valve.

According to another feature of the invention, a generator is connected to the at least one rotating part for generating electrical energy.

As stated above, the thermal engine can be charged with a working medium radially from the outside and/or radially from the inside.

The first liquid working medium is provided for absorbing thermal energy, and the at least one further liquid working medium is provided for performing work, with the at least one further liquid working medium being formed by a working medium which has a low boiling point and which is suitable for changing into a gaseous state on contact with the first liquid working medium which is enriched with thermal energy.

According to a preferred embodiment, the rotating part of the thermal engine is rotatably mounted on a rotationally fixed shaft in the form of a hollow shaft, and the hollow shaft has at least two media feed lines which extend in the axial direction, wherein one of the at least two media feed lines is provided for the first working medium, and the other one of the media feed lines is provided for the at least one further working medium, each media feed line is connected to at least one inlet duct in the lateral surface of the hollow shaft, and the inlet ducts can be connected fluidically, by rotating the rotating part, to at least one opening in each working chamber, formed by the housing part and the rotating part disposed therein, of the thermal engine.

The at least two media feed lines are preferably formed by an axial division of the cavity of the hollow shaft.

Furthermore, it is proposed that the inlet ducts of the media feed lines and the openings which correspond thereto in the working chambers are disposed with respect to one another in such a way that when the rotating part circulates, the working media can be applied successively or simultaneously to the respective working chamber.

In addition, an overpressure can be applied to the media feed lines.

In order to increase the level of efficiency of the device or of the thermal engine thereof, at least one opening for additionally charging the working chambers with the first working medium radially from the outside can be provided in the housing part of the thermal engine.

Furthermore, it may be expedient to arrange at least one venting valve, from which excess first working medium can escape during the charging of the respective working chamber with first and/or further working medium, in the housing part.

Likewise, at least one opening for additionally charging the respective working chamber, which has already been filled with the two working media, with the at least one further working medium can be provided in the housing part, as a result of which an increase, or a further increase, in the level of efficiency of the device or of the thermal engine thereof can also be brought about.

According to a further advantageous embodiment of the thermal engine of the device in question, two or more rotating parts, which are disposed coaxially with respect to one another, are connected in a rotationally fixed fashion to one another and are substantially formed in the same manner, are rotatably mounted on a common, rotationally fixed hollow shaft with media feed lines.

The rotating parts can be disposed with an angular offset with respect to one another about the central axis in such a way that an unbalance in the rotating system which is formed through expansion of the working media mixture is avoided.

The invention also provides that, one or more devices which make available thermal energy and are in the form of solar collectors, photovoltaic cells which generate electrical energy in conjunction with electrically operated heating elements, heat stores, electric heating elements per se, heat pumps, combustion systems, heat exchangers, internal combustion engines and/or the like are assigned to the circuit of the first working medium.

Furthermore, feed pumps which are integrated into the circuits of the working media and which, as is easy to understand, support a continuous circulation process in an advantageous manner have proven to be expedient.

According to a further advantageous measure, a device for spatially separating the working media and assigning the same to the respective circuit is disposed immediately downstream of the thermal engine viewed in the direction of flow of the working media or of the working media mixture.

The device for spatially separating the working media is formed by a condensation component, wherein the first liquid working medium can be discharged at the bottom of the condensation component and the at least one further working medium which is in the gaseous state can be sucked out in the upper region of the condensation component and then condensed by being cooled.

In order to advantageously support in particular the separation of the working media and the generation of a defined partial vacuum in the system, the condensation component has an integrated and extraneously driven piston-cylinder configuration.

In one embodiment of the invention, it is additionally proposed that a heat pump, whose vaporizer for cooling the working medium which is sucked out in the upper region of the condensation component and is in the gaseous state is connected to the condensation component in order to spatially separate the working media, is incorporated in the circuit of the first working medium.

In addition, the thermal engine can be assigned at least one sensor for determining the current initial temperature and/or the current initial pressure in the at least one working chamber and/or for determining the initial temperature of the first and/or at least one further working medium.

The at least one sensor is connected to a computer unit electrically or in a contactless fashion, which computer unit generates control signals and is connected to at least to an injection valve which is disposed in the circuit of the first working medium and is assigned to the inlet duct thereof, and is preferably connected to an injection valve which is disposed in the circuit of the first working medium and at least one further working medium and is assigned to the inlet duct thereof.

In accordance with the invention, there is finally also provided that the device can be used as a drive for a vehicle, in particular also as a drive in a hybrid vehicle and/or can be used for generating electrical energy through the use of at least one generator which is connected to the rotating part of the thermal engine.

With the objects of the invention in view there is also provided, a motor vehicle configuration, including:

a rotating thermal engine for driving a vehicle, the rotating thermal engine having a housing part, at least one inlet duct, an outlet duct, and at least one rotating part rotating in the housing part;

the housing part and the at least one rotating part forming at least one working chamber;

working media passing through a circulation process, the working media including a first working medium and at least one further working medium, the working media being guided in respective circuits, the respective circuits and accordingly the working media being combined temporarily within the at least one working chamber formed by the housing part and the at least one rotating part disposed therein such that thermal energy is converted into mechanical work;

the at least one further working medium having a boiling temperature lower than a boiling temperature of the first working medium;

the rotating thermal engine, the first working medium and the at least one further working medium forming a closed system provided with a given partial vacuum during a start; and

the first working medium and the at least one further working medium having a liquid aggregate state at a start of the circulation process and/or immediately prior to entering the rotating thermal engine.

According to another feature of the invention, a generator is connected to the at least one rotating part for generating electrical energy; the rotating thermal engine and the generator are configured to be used in a hybrid vehicle.

Other features which are considered as characteristic for the invention are set forth in the appended claims.

Although the invention is illustrated and described herein as embodied in a method and a device for generating mechanical energy, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of the device for generating mechanical energy through the use of a rotating thermal engine in accordance with the invention;

FIG. 2 is a diagrammatic cross-sectional view of a radial section through the thermal engine of the device according to FIG. 1 in accordance with a first exemplary embodiment of the invention;

FIG. 3 is a diagrammatic sectional view of a piston-cylinder configuration of a condensation component of the device according to FIG. 1;

FIG. 4 is a diagrammatic longitudinal sectional view of the thermal engine of the device according to FIG. 1 in accordance with a further exemplary embodiment according to the invention;

FIG. 5 is a diagrammatic cross-sectional view of a radial section of the thermal engine of FIG. 4 according to the invention;

FIG. 6 is a diagrammatic perspective view of a partial longitudinal section of the rotating part of the thermal engine according to FIG. 4 in accordance with the invention;

FIG. 7 is a diagrammatic perspective view of a partial longitudinal section of the fully assembled thermal engine according to FIG. 4 according to the invention; and

FIG. 8 is a diagrammatic perspective view of the fully assembled thermal engine according to FIG. 4 in accordance with the invention.

### DESCRIPTION OF THE PREFERRED EMBODIMENTS

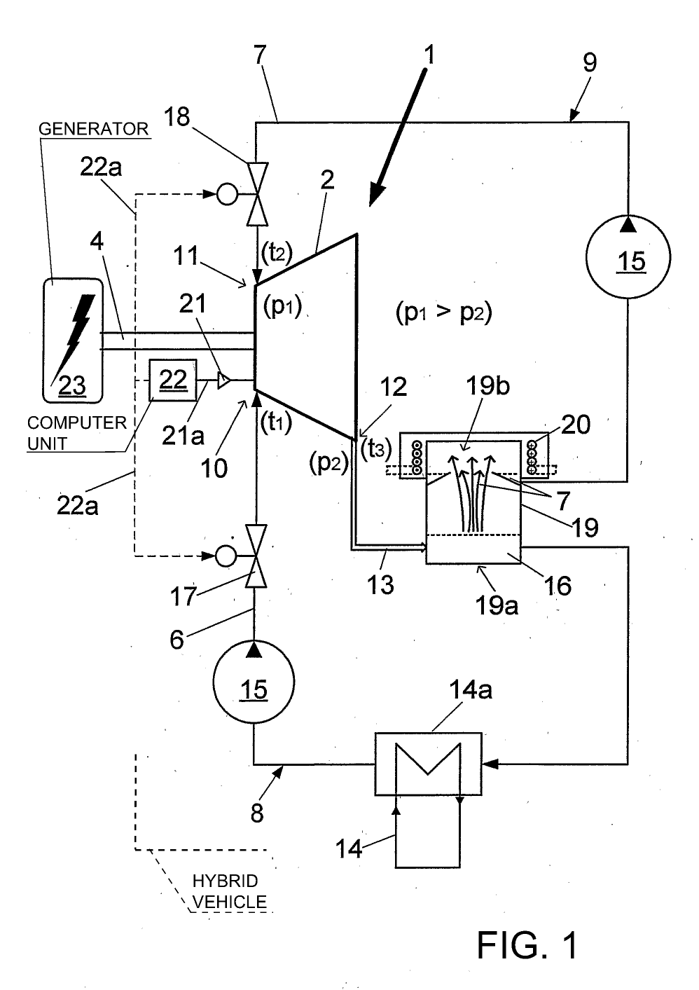

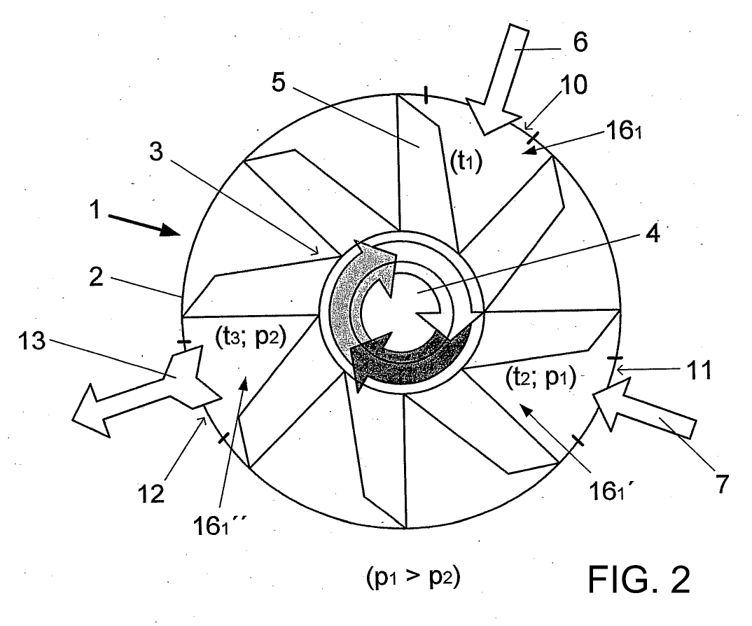

Referring now to the figures of the drawings and first, particularly, to FIGS. 1 and 2 thereof, there is shown a rotating thermal engine 1 having a housing part 2 and a part 3 which rotates therein and which is formed here by a plurality of rotor blades 5 which are disposed fixedly on a shaft 4. The thermal engine 1 which is shown corresponds, as it were in its basic structure, to a turbine which is known per se and has a turbine casing (turbine housing) and a turbine wheel which revolves therein.

According to the invention, the thermal engine 1 is operated with a first and at least one further working medium 6, 7. The working media 6, 7 are guided in different circuits 8, 9 and have a liquid aggregate state at the start of the respective circulation process or immediately before entry into the thermal engine 1.

The entire device, including in particular the thermal engine 1, the connected circuits 8, 9 and secondary assemblies, forms here a very largely closed system which is ensured by comprehensive sealing measures which are known per se.

In the present case, the thermal engine 1 is assigned two inlet ducts 10, 11 for the entry of the working media 6, 7 into it and an outlet duct 12 for carrying the working media mixture 13 out of the thermal engine 1.

Through the use of this measure, the two working media 6, 7 and, respectively, their circuits 8, 9 are therefore, as it were, directly combined on a temporary basis at least within the thermal engine 1.

Of course, in accordance with the invention, it is also possible that only one inlet duct is provided, in which case the working media 6, 7 can then be combined immediately upstream of the thermal engine 1 and/or within it.

In order then to implement a continuous circulation process of the thermal engine 1, working media 6, 7 which are liquid in the initial state and have different boiling temperatures are provided, wherein the at least one further working medium 7 has a lower boiling temperature than the first working medium 6, and is itself suitable for changing into a gaseous or vaporous state on contact with the first working medium 6 which is enriched with correspondingly high thermal energy.

The first liquid working medium 6 is therefore essentially provided for absorbing thermal energy, and the at least one further liquid working medium 7 is therefore essentially provided for performing work.

The thermal energy can be made available here to the first working medium 6 through the use of one or more suitable devices 14, for example in the form of solar collectors, photovoltaic cells which generate electrical energy in conjunction with electrically operated heating elements, heat stores, electric heating elements per se, which are, for example, mains operated, heat pumps, combustion systems, heat exchangers, internal combustion engines in which the residual heat from the combustion of fuel can be utilized and/or the like, via a heat exchanger 14a which is integrated into the circuit 8 of the first working medium 6.

In order to support the circuits 8, 9, a feed pump 15 which is known per se is disposed in each of them. The feed pump 15 can be operated electrically but also mechanically, for example operatively connected through the use of a belt drive or toothed gear drive, known per se, to the shaft 4 of the thermal engine 1.

The invention will be described further below with reference to the method according to the invention.

As already stated, the entire system is initially provided with a certain degree of partial vacuum in order, as described in more detail below, to be able to accomplish the starting-up of the system.

Subsequent to this, thermal energy is fed to the first liquid working medium 6 through the use of the devices 14 which are mentioned above.

According to a preferred embodiment, the working medium 6 which is enriched with thermal energy is formed by a viscous, non-flammable or flame-retardant, corrosion-resistant substance which absorbs large amounts of thermal energy or of heat. To this extent, for example, a 1.2 or 1.3 propandiol/water mixture, known commercially as “SOLARFLUID L” or “TYFOCOR LS” is suitable for this.

The invention is, however, not restricted to the above-mentioned substance but includes all suitable substances which are known per se and which largely allow for the features above, have a melting point below −30° C. and a boiling point above 180° C. and do not become chemically combined with the further working medium 7 when heated.

It is also considered expedient if the working medium 6 is heated to a working temperature from approximately 140° C. to just under the boiling point.

The first working medium 6 which is enriched with thermal energy is, as shown in FIG. 2, now injected, owing to the line pressure which was built up by the feed pump 15 of the respective of circuit 8, at a time “t₁” radially from the outside through the use of an injection valve 17 via a first inlet duct 10 of the housing part 2 of the thermal engine 1 into a working chamber 16₁ which is formed by the rotating part 3 (turbine wheel) or its rotor blades 5 and the housing part 2.

When the system starts up, the rotational movement of the rotating part 3 is firstly brought about here through the use of an external drive, for example an electric drive. Likewise, the first inlet duct 10 of the housing part 2 can also be disposed in such a way that the force of gravity acting on the working medium 6 which is injected into the working chamber 16₁ already brings about a certain desired rotational movement of the rotating part 3.

If the working chamber 16₁ has reached the second inlet duct 11 at a time “t₂”, at least one further, initially liquid working medium 7, which itself has a lower boiling temperature than the first working medium 6, is fed to the working chamber 16₁ (16₁′) and accordingly to the first working medium 6 which is enriched with thermal energy, the further working medium 7 also being fed radially from the outside via an injection valve 18, preferably at high pressure.

Liquid alkanes such as, for example, hexane, with a boiling point of approximately 68.7° C. or heptane, with a boiling point of 98.4° C. are appropriate for this. Likewise, monohydric alcohols, for example 2-propanol with a boiling point of 82.3° C., propanol with a boiling point of 97° C. or ethanol with a boiling point of 78.3° C. can be used. In addition, alicyclic compounds of the cycloalkanes such as, for example, cyclopentane, cyclohexane, cycloheptane with a boiling point of approximately 70° C. to approximately 100° C. are also conceivable. Finally, other liquids which are known per se, are slow reactors but boil easily, such as azeotropic mixtures, alkenes or metylalkanes, are also conceivable.

Being certainly easy to comprehend for a person skilled in the art, the preferred substances above are specified only by way of example. Nevertheless, a large number of other substances which are known per se and suitable, for example even water, are also conceivable instead.

With regard to the conceivable combinations of suitable working media 6, 7, it is to be ensured in all cases that the working media 6, 7 do not form chemical compounds and that the further working medium 7 requires a low level of evaporation heat.

Owing to the combination of the two working media 6, 7, the working medium 7 with a low boiling point goes into a gaseous or vaporous state accompanied by the performance of work. It expands and thus generates an overpressure “p₁” which itself applies a torque to the rotating part 3 of the thermal engine 1, the torque moving the working chamber 16₁ (16₁′) in the direction of the outlet duct 12 of the thermal engine 1.

Of course, in order to bring about a uniform rotational movement of the rotating part 3 of the thermal engine the subsequent working chambers 16₂₋ₙ are also charged, as described above, with working media 6, 7.

If the working chamber 16₁ (16₁″) has reached the outlet duct 12 at a time “t₃”, the generated working media mixture 13, which is composed of still liquid first working medium 6 and gaseous working medium 7, is extracted from the thermal engine 1, as it were sucked out of it, owing to the partial vacuum “p₂”, initially applied to the system and accordingly present at the outlet duct 12, of the working chamber 16₁ (16₁″), and the working media mixture 13 is finally cooled.

A suitable device for cooling the working media mixture 13 and for spatially separating the working media 6, 7 is formed here by a condensation component 19 in which the at least one working medium 7 with a low boiling point is changed again into the liquid initial state by condensation of the working medium.

As a result of the cooling of the working media mixture 13, in particular of the working medium 7 with a low boiling point and its condensation, the partial vacuum “p₂” which is set at the beginning or the pressure gradient “p₁>p₂” is maintained in the system in order to remove subsequent working media mixtures 13 and to ensure the continuous circulation process.

FIG. 1 shows such a condensation component 19 in an extremely schematic form, with the first liquid working medium 6 being capable of being discharged at the bottom 19a of the condensation component 19 and it being possible to suck out the at least one further working medium 7 which is in the gaseous state in an upper bell-like region 19b of the condensation component 19, and to feed it to the condensation by cooling.

For the purpose of cooling, cooling coils 20 of a vaporizer of a heat pump are provided here, the heat pump being itself integrated into the circuit 8 of the first working medium 6. Other cooling measures which are known per se, for example air cooling, are certainly also conceivable. The thermal energy which is carried away can be used here for renewed heating of the first working medium 6 and/or for heating a third working medium and/or heating process water.

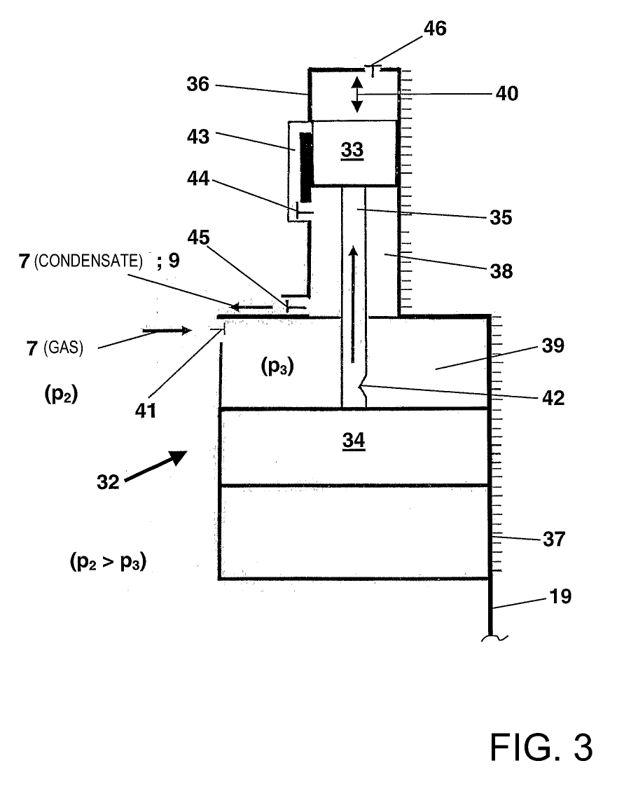

In order to control any supply of air from the outside due to leaks in the system and to promote advantageously the separation of the working media 6, 7 and the generation of a defined partial vacuum in the system, it is possible to provide an extraneously driven and cooled piston/cylinder configuration 32 (FIG. 3) in the upper region of the condensation component 19 for condensing and cooling the further working medium 7 which is in the gaseous state.

The piston-cylinder configuration 32 includes essentially an upper and a lower piston 33, 34 which themselves are securely connected to one another through the use of a rigid, elongated rod component 35 and are each guided axially in a cylinder 36, 37.

The two cylinders 36, 37 are connected to one another via a bore in which the rod component 35 is guided in a seal-forming fashion.

The upper piston 33 bounds an upper working space 38 toward the lower piston 34, while the lower piston 34 bounds a lower working space 39 toward the upper piston 33.

The combination of pistons 33, 34 and rod component 35 can be moved axially within the cylinders 36, 37 through the use of an extraneous drive 40 (known per se and accordingly not shown in more detail), it being possible for the extraneous drive 40 to be operated electrically, mechanically or electromechanically.

The method of functioning of the piston-cylinder configuration 32 is in this case as follows:

Gaseous working medium 7 and any external air which has penetrated the system due to leaks in the system is sucked into the lower working space 39 owing to a partial vacuum in the working space 39 through a valve 41, which can be a ball valve which is open on one side. In this case, the pressure “p₂” (partial vacuum) in the condensation component 19 is greater than the pressure “p₃” (partial vacuum) of the working space 39.

Subsequent to this, the lower piston 34 is moved to a top dead center through the use of the extraneous drive 40, a compression of the gaseous working medium 7 together with any air, accompanied by a certain degree of heating, being produced. The valve 41 is closed.

If a certain degree of travel takes place, an exchange of media is brought about via a working duct 42 which is formed in the external contour of the rod component 35, since the upper piston 33 has been pushed upward accompanied by the generation of a partial vacuum. The working medium 7 and any air flow into the upper working space 38 accompanied by relaxation and cooling, and the working medium 7 condenses, possibly promoted by additional cooling from outside.

If the combination of pistons 33, 34 and rod component 35 is moved downward again, firstly the working duct 42 of the rod component 35 is pushed downward out of its working position and accordingly the bore is closed off again in a seal-forming fashion by the rod component 35. Any air can pass via a flow duct 43 with valve 44 into an upper region of the cylinder 36 owing to a build-up of pressure in the lower region of the upper cylinder 36, the flow duct 43 being closed and opened by the movement of the upper piston 33 and the valve 44.

Secondly, a valve 45, which is disposed at the upper working space 38 and which can be actuated by sensor or mechanically and can also be a ball valve which is open at one end, is opened in the lower third of the downward directed piston movement, and the condensed working medium 7 is transferred to the associated media circuit 9. At the next upward directed movement of the piston unit, i.e. when the upper piston 33 reaches the top dead center, any air is discharged via a valve 46 or removed from the system.

For a person skilled in the art it is self-evident that the movement of the combination of pistons 33, 34 and rod component 35 takes place as a direct function of the rotational speed of the thermal engine 1 and accordingly of the provision of working media mixture 13, if necessary continuously under computer control.

However, on the other hand it can also be indicated that, instead of the piston-cylinder configuration 32, a partial vacuum pump (known per se) can be used with cooling, a cooler being connected upstream and/or downstream of the pump. In this case, the condensate of the working medium 7 must be fed back into the system with exclusion of air. Such a configuration is therefore also covered by the invention.

Finally, both working media 6, 7 are fed back in the liquid state into the circulation process or into the respectively assigned separate circuit 8, 9 through the use of the feed pumps 15.

A person skilled in the art will certainly easily recognize that the working media 6, 7 should also be selected as a function of the respective location of use so that the aggregate state which is necessary in the system for process reasons is also maintained or brought about for all the expected temperature ranges at the location of use.

In addition it is indicated that the volume of the working media 6, 7 which are fed to the at least one working chamber 16₁₋ₙ can be determined under computer control as a function of the sensed current initial temperature and/or the sensed current initial pressure in the working chamber 16₁₋ₙ and/or the current initial temperature of the first working medium 6 and/or the at least one further working medium 7.

In this regard, at least one suitable pressure and/or temperature sensor 21 which is known per se and which is itself connected electrically or in a contactless fashion to a computer unit 22 is provided (FIG. 1).

This computer unit 22 itself generates control signals 22a for at least one of the two injection valves 17, 18 of the circuits 8, 9, preferably for both injection valves 17, 18 of the circuits 8, 9 as a function of the signals 21a which are made available by the at least one sensor 21 and using predetermined comparison values, as a result of which the injection volume of the working media 6, 7 and the optimum amount of vaporizing liquid (working medium 7) can be advantageously regulated in order to ensure a continuous circulation process and a high degree of efficiency of the thermal engine 1.

If more thermal energy than required is made available through the use of the at least one device 14, for example a solar collector, which is making available thermal energy, the energy can be used for heating purposes and/or stored. For example, what are referred to as long-term latent heat storage systems with a suitable storage medium such as a salt solution or a paraffin whose melting point has been influenced, are appropriate as storage systems.

As is also apparent from FIG. 1, a generator 23 which is known per se is expediently connected to the rotating part 3 of the thermal engine 1 or to the shaft 4 thereof in order to generate electrical energy.

The exemplary embodiment above relies essentially on a thermal engine 1 in the manner of a turbine which is known per se and has a turbine casing and a turbine wheel which rotates therein, with the working media 6, 7 being fed to the working chambers 16₁₋ₙ through inlet ducts 10, 11 in the housing part 2 of the thermal engine 1 exclusively radially from the outside.

However, it is also conceivable, and is also covered by the invention, to use a thermal engine 1 in the manner of a motor with a motor casing and with a piston rotating therein by analogy with a rotary piston engine, wherein the thermal reaction of a liquid working medium 7 in the sense of only changing the aggregate state, specifically from the liquid state to the gaseous state, and a resulting expansion thereof, associated with the performance of work, are used instead of the conventional combustion of fuel.

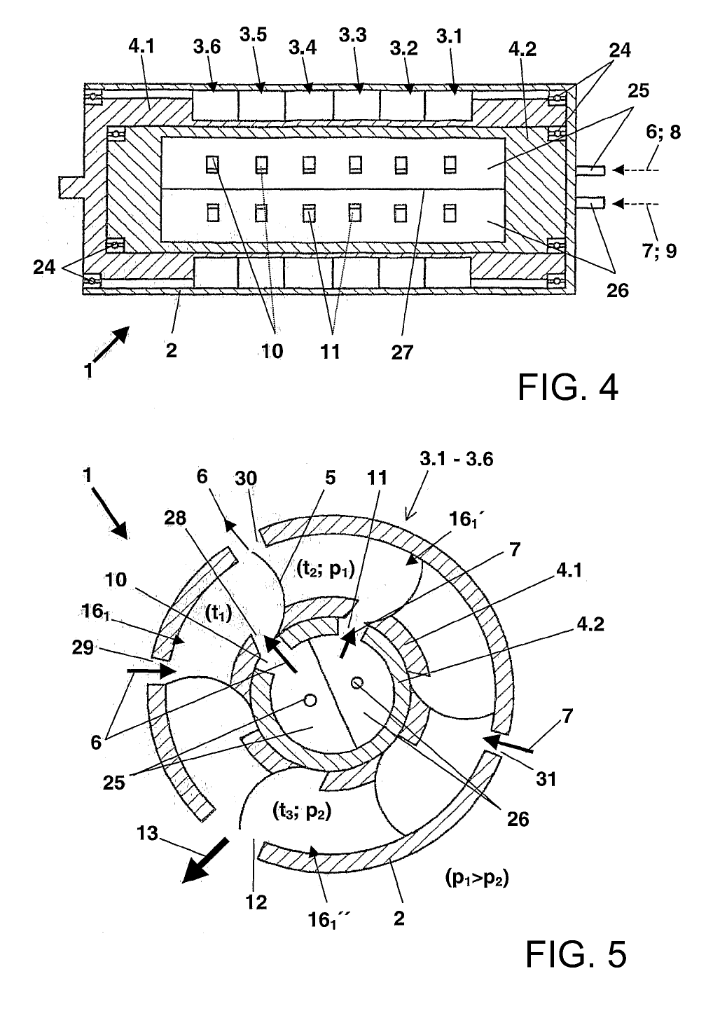

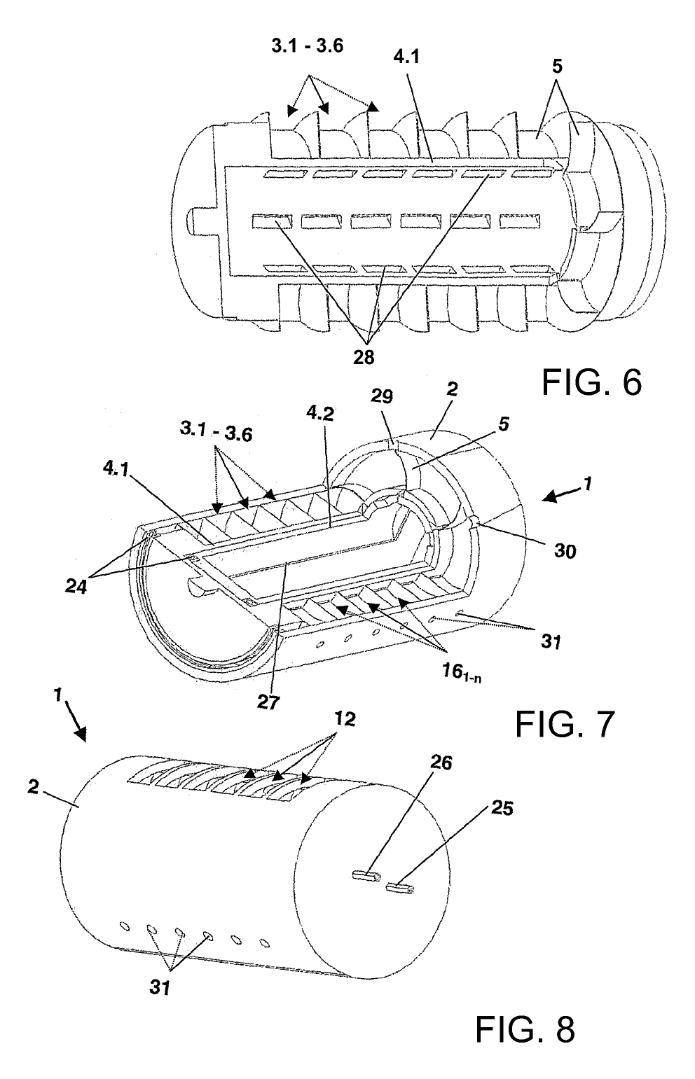

The embodiment variant of a thermal engine 1 of the device for generating mechanical energy which is shown in FIGS. 4 to 8 differs from that described above essentially in that a common, fixedly positioned housing part 2 and a plurality of rotating parts 3.1 to 3.6, six in the present case, which are disposed therein coaxially and rotationally fixed with respect to one another are provided with working chambers 16₁₋ₙ which are formed by the housing part 2 and the rotating parts 3.1 to 3.6 and which are each formed here by a plurality of rotor blades 5 which are fixedly disposed on a common hollow shaft 4.1 and are distributed uniformly over the circumference.

The parts 3.1 to 3.6 which rotate in the clockwise direction according to FIG. 5 or their common hollow shaft 4.1 are rotatably supported through the use of roller bearings 24 on the one hand on the inner casing surface of the housing part 2 and on the other hand on the outer casing surface (lateral surface) of a shaft 4.2 which is connected in a rotationally fixed fashion to the housing part 2, with the radial spacing between the rotating parts 3.1 to 3.6 and the fixed housing part 2 as well as the fixed shaft 4.2 being minimized in such a way that although relative movement is permitted the working chambers 16₁₋ₙ which are formed by the housing part 2 and the rotating parts 3.1 to 3.6 are at least largely liquid-tight but preferably gas-tight.

This thermal engine 1 is also operated with a first and at least one further working media 6, 7 of the type described in more detail above, the working media 6, 7 being guided in different circuits 8, 9.

The working media 6, 7 are fed via media feed lines 25, 26 integrated in the circuits 8, 9 to the shaft 4.2 which is fixedly disposed in the housing part 2 and is embodied here as a hollow shaft.

The shaft 4.2 in the form of a hollow shaft has, according to a preferred embodiment, an axial division which is itself implemented through the use of a dividing wall 27. The dividing wall 27 preferably has a thermal insulation, in order to largely avoid exchange of heat between the two working media 6, 7 within the shaft 4.2.

Through the use of the above measures, the media feed lines 25, 26 are easily and cost-effectively axially routed to the rotating parts 3.1 to 3.6, with the media feed line 25 being provided here for the first working medium 6 and the media feed line 26 being provided for the at least one further working medium 7.

Of course, it can also be indicated, and is accordingly also covered by the invention, that instead of an axial division of the shaft (hollow shaft) 4.2 the media feed lines 25, 26 are divided and partial lines are routed to the rotating parts 3.1 to 3.6 which are disposed axially one behind the other.

One inlet duct 10 for the first working medium 6 and one inlet duct 11 for the at least one further working medium 7 are assigned to each rotating part 3.1 to 3.6 in the casing surface (lateral surface) of the rotationally fixed shaft 4.2/hollow shaft.

The inlet ducts 10, 11 can themselves be connected fluidically (see in particular FIG. 5) by rotation, to be carried out in the clockwise direction here, of the respectively assigned rotating part 3.1 to 3.6 in succession in each case with an opening 28 of a working chamber 16₁₋ₙ which is formed by the housing part 2 and the corresponding rotating part 3.1 to 3.6 which is disposed therein.

The openings 28 of all the rotating parts 3.1 to 3.6 are made here in the casing of the common hollow shaft 4.1 of the rotating parts 3.1 to 3.6 and are preferably embodied, in terms of their fluid dynamics, as a nozzle, as a result of which the flow rate of the working media 6, 7 can be advantageously increased.

In contrast to the embodiment variant of the thermal engine 1 which was described first, the working media 6, 7 are now primarily fed to the working chamber 16₁₋ₙ radially from the inside, i.e. via the centrally disposed, fixed shaft 4.2.

Furthermore, the rotating parts 3.1 to 3.6 of the thermal engine 1 are each assigned one outlet duct 12 in the wall of the housing part 2 for conducting the working media mixture 13 out of the thermal engine 1.

The working media 6, 7 or their circuits 8, 9 can, as already mentioned above, be combined directly within the thermal engine 1.

In order to implement a continuous circulation process of the thermal engine 1, within the sense of the invention, working media 6, 7 which are also liquid in the initial state are provided with different boiling temperatures, with the at least one further working medium 7 having a lower boiling temperature than the first working medium 6 and itself being suitable for changing into a gaseous or vaporous state on contact with the first working medium 6 which is enriched with correspondingly high thermal energy.

The first liquid working medium 6 is accordingly also provided for absorbing thermal energy and the at least one further liquid working medium 7 for performing work.

A detailed description has already been given of the measures of enriching the first working medium 6 with thermal energy and for ensuring the circulation process and the circuits 8, 9.

Referring to FIG. 5, in such a thermal engine 1, the first working medium 6 which is enriched with thermal energy is injected via the opening 28 at a time “t₁” with overpressure via the inlet duct 10 into a working chamber 16₁ which is formed by the rotating parts 3.1 to 3.6 or their rotor blades 5 and the housing part 2.

The flow energy of the injected, first working medium 6 into the working chamber 16₁ can be used to start the system. The inlet duct 10 can also be disposed in such a way that the acting force of gravity of the working medium 6 brings about a certain rotational movement of the rotating parts 3.1 to 3.6.

The desired rotational movement for starting the system can also be made available by an external drive, for example an electric drive.

If the working chamber 16₁ has reached the downstream, second inlet duct 11 at a time “t₂”, the at least one further, initially liquid working medium 7 is fed, also with overpressure, through the opening 28 to the working chamber 16₁ (16₁′) and accordingly to the first working medium 6 which is enriched with thermal energy, the further working medium 7 itself having a lower boiling temperature than the first working medium 6.

Owing to the combination of the two working media 6, 7, the working medium 7 with the low boiling point goes into a gaseous or vaporous state accompanied by the performance of work. The working medium 7 expands and thus generates an overpressure “p₁”, which itself applies a torque to the rotating parts 3.1 to 3.6 of the thermal engine 1, the torque moving the working chamber 16₁ (16₁′) in the direction of the outlet duct 12 of the thermal engine 1. Of course, the respectively following working chambers 16₂₋ₙ can also be charged with working media 6, 7 as described above in order to implement a uniform rotational movement of the rotating part 3.1 to 3.6 of the thermal engine 1.

In this context it is also noted that the fact that the working media 6, 7 are introduced initially into the working system with overpressure has an advantageous effect on an increased temperature profile, in particular of the second working medium 7 in the working system.

If the working chamber 16₁ (16₁″) has reached the outlet duct 12 at a time “t₃”, the generated working media mixture 13, composed of a still liquid first working medium 6 and gaseous working medium 7 owing to the partial vacuum “p₂” which is initially applied to the system and is accordingly present at the outlet duct 12, is removed from the working chamber 16₁ (16₁″) of the thermal engine 1, as it were sucked out of it, and is finally cooled.

As described above, the inlet ducts 10, 11 of the media feed lines 25, 26 and the openings 28 which correspond to the latter in the working chambers 16₁₋ₙ are disposed with respect to one another in such a way that when the rotating part 3.1 to 3.6 revolves the working media 6, 7 are applied successively to the respective working chamber 16₁₋ₙ.

However, in contrast, it may also be indicated that the working media 6, 7 can be applied simultaneously to the respective working chamber 16₁₋ₙ, and this is therefore also covered by the invention.

As is apparent in particular with reference to FIG. 5, the housing part 2 has an opening 29 which is assigned to each rotating part 3.1 to 3.6 and has the purpose of additionally charging the working chambers 16₁₋ₙ with first working medium 6 radially from the outside while simultaneously charging with first working medium 6 radially from the inside, as a result of which the efficiency of the thermal engine 1 can be increased further.

In order to ensure a defined volume of first working medium 6 in the respective working chamber 16₁₋ₙ, it is possible, during the charging with first working medium 6 and/or with the further working medium 7, for excess first working medium 6 to escape via a venting valve 30 in the wall of the housing part 2.

In order to increase the efficiency of the thermal engine 1 even further, at least one opening 31 for additionally charging the respective working chamber 16₁₋ₙ, which has already been filled with both working media 6, 7, with the at least one further working medium 7 is also provided in the housing part 2.

However, the charging requires an overpressure which lies above the internal pressure which becomes established in the respective working chamber 16₁₋ₙ at this time owing to an expansion of the working medium 7 with the low boiling point. An injection nozzle is considered expedient here.

It is also considered expedient for the rotating parts 3.1 to 3.6 to be disposed with an angular offset with respect to one another about the central axis in such a way that during ongoing operation of the thermal engine 1 an unbalance in the rotating system thereof which is formed owing to expansion of the working media mixture 13 is avoided.

This exemplary embodiment relies on a plurality of rotating parts 3.1 to 3.6, i.e. on two or more, which are disposed coaxially with respect to one another, are connected to one another in a rotationally fixed fashion and are largely of the same design, the rotating parts 3.1 to 3.6 being rotatably mounted on a common, rotationally fixed shaft 4.2 in the form of a hollow shaft with media feed lines 25, 26.

Of course, a thermal engine 1 with a single rotating part 3.1 of the type described above is also part of the scope of the invention and is accordingly also covered by the invention.

As was stated in particular with respect to the embodiment variant of the thermal engine 1 which was described first, the thermal engine 1 can be embodied in the manner of a turbine with a turbine casing and a turbine wheel which rotates therein, with the generation of electrical energy being proposed as a particular application case.

In addition to this, it is also appropriate to use the thermal engine 1 as a drive for a vehicle owing, in particular, to the particularly compact design of the thermal engine 1.

The thermal engine 1 can therefore also be used, for example, as a drive in a hybrid vehicle, which is only schematically indicated by a dashed line in FIG. 1, wherein it is possible to make available the necessary thermal energy from, for example, the residual heat of an internal combustion engine or other suitable internal or else external heat sources, such as for example solar energy.

Owing to the fact that the thermal engine 1 according to the invention has relatively low working temperatures compared to the prior art and as a function of the selected working media 6, 7, it is not necessary to use any high-strength materials. It is therefore conceivable for suitable lightweight metals or plastics to be used, which results in a reduced weight and accordingly a further increase in the efficiency. Considerable cost savings are therefore obtained compared to conventional thermal engines.

### LIST OF REFERENCE NUMERALS

1 Thermal engine
2 Housing part
3 Rotating part
3.1-3.6 Rotating parts
4 Shaft
4.1 Hollow shaft (rotating parts 3.1-3.6)
4.2 Shaft
5 Rotor blades
6 First working medium
7 Further working medium
8 Circuit (first working medium 6)
9 Circuit (further working medium 7)
10 Inlet duct (first working medium 6)
11 Inlet duct (further working medium 7)
12 Outlet duct
13 Working media mixture
14 Device which supplies thermal energy
14a Heat exchanger
15 Feed pumps
16₁₋ₙ Working chambers
17 Injection valve
18 Injection valve
19 Condensation component
19a Bottom (condensation component 19)
19b Upper region (condensation component 19)
20 Cooling coils
21 Sensor
21a Signals
22 Computer unit
22a Control signals
23 Generator
24 Roller bearing
25 Media feed line (first working medium 6)
26 Media feed line (further working medium 7)
27 Dividing wall
28 Opening (hollow shaft 4.1)
29 Opening (housing part 2)
30 Venting valve
31 Opening
32 Piston-cylinder configuration
33 Upper piston
34 Lower piston
35 Rod component
36 Upper cylinder
37 Lower cylinder
38 Upper working space
39 Lower working space
40 Extraneous drive
41 Valve
42 Working duct
43 Flow duct
44 Valve
45 Valve
46 Valve

What is claimed is:

1. A method for generating mechanical energy, the method which comprises:
providing a rotating thermal engine having a housing part, at least one inlet duct, an outlet duct, and at least one rotating part rotating in the housing part, wherein thermal energy is converted into mechanical work and working media pass through a circulation process;
carrying out the following steps successively in a closed system which is initially provided with a given partial vacuum;
a) supplying thermal energy to a first working medium in a liquid state;
b) feeding the first working medium, which is enriched with thermal energy, in a liquid state to at least one working chamber which is formed by the housing part and the at least one rotating part which is disposed in the housing part;
c) feeding at least one further working medium in a liquid state to the first working medium in the liquid state within the at least one working chamber, the at least one further working medium having a boiling temperature that is lower than a boiling temperature of the first working medium, wherein the at least one further working medium changes into a gaseous state or expands as a result of being combined with the first working medium enriched with thermal energy, and the at least one further working medium generates an overpressure and performs work in such a way that a torque is applied to the rotating part;
d) extracting, after a given rotation of the at least one rotating part, a working media mixture which is composed of the first working medium and the at least one further working medium, wherein the working media mixture is extracted from the at least one working chamber through the outlet duct in the housing part as a result of a partial vacuum present at the outlet duct, and subsequently cooling the working media mixture, as a result of which a continuous pressure gradient in a system is maintained in order to extract a following working media mixture and to ensure a continuous circulation process; and
e) spatially separating the working media from one another and feeding the working media back into the circulation process and, respectively, into separate circuits.

2. The method according to claim 1, which comprises supplying the thermal energy for the first working medium by using at least one thermal energy-supplying device selected from the group consisting of a solar collector, a photovoltaic cell generating electrical energy in conjunction with an electrically operated heating element, a heat storage device, an electric heating element, a heat pump, a combustion system, a heat exchanger, and an internal combustion engine.

3. The method according to claim 1, which comprises feeding at least one of the first and the at least one further working medium to the at least one working chamber in a controlled manner by using a respective injection valve.

4. The method according to claim 3, which comprises determining a volume of the working media which are fed to the at least one working chamber in a computer-controlled manner in dependence on at least one sensed value selected from the group consisting of a sensed current initial temperature, a sensed current initial pressure in the at least one working chamber, a current initial temperature of the first working medium, and a current initial temperature of the at least one further working medium.

5. A device for generating mechanical energy, comprising:
a rotating thermal engine having a housing part, at least one inlet duct, an outlet duct, and at least one rotating part rotating in said housing part;
said housing part and said at least one rotating part forming at least one working chamber;
working media passing through a circulation process, said working media including a first working medium and at least one further working medium, said working media being guided in respective circuits, said respective circuits and accordingly said working media being combined temporarily within said at least one working chamber formed by said housing part and said at least one rotating part disposed therein such that thermal energy is converted into mechanical work;
said at least one further working medium having a boiling temperature lower than a boiling temperature of said first working medium;
said rotating thermal engine, said first working medium and said at least one further working medium forming a closed system provided with a given partial vacuum during a start; and
said first working medium and said at least one further working medium having a liquid aggregate state at least at one of a start of the circulation process and immediately prior to entering said rotating thermal engine.

6. The device according to claim 5, wherein said rotating thermal engine is configured to be charged with said working media radially from at least one of outside and inside.

7. The device according to claim 5, wherein:
said first working medium is provided for absorbing thermal energy;
said at least one further working medium is provided for performing work; and
said at least one further working medium has a given boiling temperature such that said at least one further working medium is suitable for changing into a gaseous state on contact with said first working medium which is in a liquid aggregate state and enriched with thermal energy.

8. The device according to claim 5, wherein:
said rotating thermal engine has a rotationally fixed shaft embodied as a hollow shaft;
said at least one rotating part of said rotating thermal engine is rotatably mounted on said rotationally fixed shaft;
said hollow shaft has at least two media feed lines, said hollow shaft defines an axial direction and said at least two media feed lines extend in the axial direction;
a first one of said at least two media feed lines is provided for said first working medium, and a further one of said at least two media feed lines is provided for said at least one further working medium;
said hollow shaft has a lateral surface, said at least one inlet duct is configured as inlet ducts provided in said lateral surface of said hollow shaft;
each of said at least two media feed lines is connected to at least a respective one of said inlet ducts in said lateral surface of said hollow shaft; and
said inlet ducts are configured to be fluidically connectable, by rotating said at least one rotating part, to at least one opening formed in said at least one working chamber of said thermal engine.

9. The device according to claim 8, wherein:
said hollow shaft has a cavity formed therein; and
said cavity is an axially divided cavity forming said at least two media feed lines.

10. The device according to claim 8, wherein said inlet ducts in said lateral surface of said hollow shaft and said at least one opening formed in said at least one working chamber of said rotating thermal engine are disposed in a manner corresponding with one another such that when said at least one rotating part rotates, said working media can be supplied one of successively and simultaneously to said at least one working chamber.

11. The device according to claim 8, wherein said at least two media feed lines have an overpressure applied thereto.

12. The device according to claim 8, wherein said housing part has at least one opening formed therein for additionally charging said at least one working chamber with said first working medium radially from outside.

13. The device according to claim 8, including at least one venting valve disposed in said housing part, said at least one venting valve being configured such that an excess amount of said first working medium can escape during a charging of said at least one working chamber with at least one of said working media.

14. The device according to claim 8, wherein said housing part has at least one opening formed therein for additionally charging said at least one working chamber, which is already filled with said first and said at least one further medium, with said at least one further working medium.

15. The device according to claim 8, wherein:
said at least one rotating part is embodied as at least two substantially identically formed rotating parts disposed coaxially with respect to one another and rotationally fixed with respect to one another; and
said at least two substantially identically formed rotating parts are rotatably mounted on said rotationally fixed shaft.

16. The device according to claim 15, wherein said at least two substantially identically formed rotating parts define a central axis and are disposed with an angular offset with respect to one another about the central axis such that an unbalance in a rotating system resulting from an expansion of a mixture of said working media is avoided.

17. The device according to claim 5, wherein:
said first working medium is guided in a given one of said circuits; and
at least one thermal energy-supplying device selected from the group consisting of a solar collector, a photovoltaic cell generating electrical energy in conjunction with an electrically operated heating element, a heat storage device, an electric heating element, a heat pump, a combustion system, a heat exchanger, and an internal combustion engine is assigned to said given one of said circuits.

18. The device according to claim 5, wherein at least one respective feed pump is disposed in each respective one of said circuits for said working media.

19. The device according to claim 5, wherein:
said working media define a direction of flow; and
a separating device is provided directly downstream of said rotating thermal engine viewed in the direction of flow of said working media, said separating device is configured to spatially separate said working media and to assign respective ones of said working media to respective ones of said circuits.

20. The device according to claim 19, wherein:
said separating device is a condensation component having a bottom and an upper region; and
said separating device is configured such that said first working medium can be discharged at said bottom of said condensation component and said at least one further working medium, which is in a gaseous state, can be sucked off in said upper region of said condensation component and condensed by being cooled.

21. The device according to claim 20, wherein said condensation component has an integrated and extraneously driven piston-cylinder configuration configured to provide at least a defined support for a separation of said working media and a defined generation of a constant partial vacuum in said condensation component.

22. The device according to claim 20, wherein a given one of said circuits guides said first working medium and has a heat pump integrated therein, said heat pump has an evaporator connected to said condensation component for cooling said at least one further working medium which is sucked off in said upper region of said condensation component in the gaseous state.

23. The device according to claim 5, including at least one sensor assigned to said rotating thermal engine, said at least one sensor determining at least one sensor value selected from the group consisting of a current initial temperature value in said at least one working chamber, a current initial pressure value in said at least one working chamber, an initial temperature value of said first working medium and an initial temperature value of said at least one further working medium.

24. The device according to claim 23, including:
a computer unit connected to said at least one sensor via one of an electrical connection and a contactless connection;
said circuits including a first circuit for guiding said first working medium and a further circuit for guiding said at least one further working medium;
said at least one inlet duct including a first inlet duct for said first working medium and a further inlet duct for said at least one further working medium;
a first injection valve provided in said first circuit and assigned to said first inlet duct;
a further injection valve provided in said further circuit and assigned to said further inlet duct; and
said computer unit generating control signals and being operatively connected to at least one injection valve selected from the group consisting of said first injection valve and said further injection valve.

25. The device according to claim 5, including a generator connected to said at least one rotating part for generating electrical energy.

26. A motor vehicle configuration, comprising:
a rotating thermal engine for driving a vehicle, said rotating thermal engine having a housing part, at least one inlet duct, an outlet duct, and at least one rotating part rotating in said housing part;
said housing part and said at least one rotating part forming at least one working chamber;
working media passing through a circulation process, said working media including a first working medium and at least one further working medium, said working media being guided in respective circuits, said respective circuits and accordingly said working media being combined temporarily within said at least one working chamber formed by said housing part and said at least one rotating part disposed therein such that thermal energy is converted into mechanical work;
said at least one further working medium having a boiling temperature lower than a boiling temperature of said first working medium;
said rotating thermal engine, said first working medium and said at least one further working medium forming a closed system provided with a given partial vacuum during a start; and
said first working medium and said at least one further working medium having a liquid aggregate state at least at one of a start of the circulation process and immediately prior to entering said rotating thermal engine.

27. The motor vehicle configuration according to claim 26, including:
a generator connected to said at least one rotating part for generating electrical energy; and
said rotating thermal engine and said generator being configured to be used in a hybrid vehicle.
